(19) United States
(12) Patent Application Publication
(10) Pub. No.: US 2013/0190017 A1
(43) Pub. Date: Jul. 25, 2013

(54) Melt Crush MG

(71) Applicant: Joseph George, Downey, CA (US)

(72) Inventor: Joseph George, Downey, CA (US)

(21) Appl. No.: 13/706,257

(22) Filed: Dec. 5, 2012

Related U.S. Application Data
(60) Provisional application No. 61/630,145, filed on Dec. 5, 2011.

(51) Int. Cl. H04W 4/00; H04W 4/02

(52) U.S. Cl. CPC H04W 4/003; H04W 4/025
USPC 455/456.3; 455/556.1

(57) ABSTRACT

The invention provides a multifunctional cellular phone specifically designed for international calling with integrated features, programs and applications, and specifically comprises an embedded international calling program.

### CLAIM OF PRIORITY

This patent application claims priority under 35 USC 119 (e) (1) from U.S. Provisional Patent Application Ser. No. 61/630,145, filed Dec. 5, 2011, of common inventorship herewith entitled, “Melt Crush MG.”

### FIELD OF THE INVENTION

The present invention pertains to the field of mobile electronic devices, and more specifically to the field of cellular phones/smartphones and international calling.

### BACKGROUND OF THE INVENTION

The prior art has put forth several designs for mobile electronic devices. Among these are:

U.S. Pat. No. 7,519,386 to Klaus Kespohl, Karsten Lehn, Andre Koll, Stefanie Vollinger, Konrad Brisse, and Peter Buth describes a controlling arrangement for a music player application in a mobile communication device. A multifunctional soft button with four switching positions and a mode switching arrangement are provided on the keyboard layout to improve the control of the music player. The application switches into two different modes with the switching arrangement and the multifunction soft button contains different functionalities depending on mode of the application.

U.S. Pat. No. 7,285,711 to Toshiharu Okada, Kaoru Tsukamoto, Tomohiro Iwanaga, and Yoji Hamano describes a music player for playing music data such as musical instrument digital interface, MIDI, data. The music player is applicable to a mobile phone, a personal digital assistant, a game player, and an MIDI player. The object of this invention is to provide a music player capable of controlling a plurality of sequencer's with a simple program without an OS, Operating System, or a scheduler. Each of the sequencers includes a reading and restoring function unit, a message analyzing and processing unit, a writing function unit, and a sequencer controlling unit. Each of these function units is controlled separately with a simple program.

U.S. Pat. No. 6,782,278 to Kun-Huei Chen and Chin-Tai Chuang describes a dialing method for dynamically simplifying the international call in a cellular phone. This method utilizes a conversion table, which stores system codes of a plurality of network companies worldwide and their international access codes and is used in conjunction with international roaming. This method also contains a phone record for storing telephone numbers with international access codes, national codes and area codes after they have been dialed. After these numbers are stored in the database, they can be retrieved and a call initiated to the receiving party without having to know the corresponding international access codes or area codes.

None of these prior art references describe the present invention.

### SUMMARY OF THE INVENTION

It is an object of the present invention to provide a multifunctional cellular phone specifically designed for international calling with integrated features, programs and applications, specifically an embedded international calling program, for example program.

### BRIEF DESCRIPTION OF THE DRAWINGS

FIG. 1 shows top perspective views of the present invention with its front application screen as the largest view labeling the Call, International Call, End call, Perfect Music MG, Camera, and Internet capabilities. Surrounding product views show the present invention's LED screen and keyboard with sliding open capability, hinged flip open capability, and a touch screen version. A version with a touch screen keyboard is also showing. Perspective views of wireless flexible earpieces as earphones with Bluetooth functions and high speaker functions are shown in this FIG. 1.

### DETAILED DESCRIPTION OF THE INVENTION

Telecommunications have played an important role in society for over a century. Today's telephones are minicomputers possessing the ability to identify the caller, store the caller's number, and automatically return the call with the push of a button. In addition to making phone calls from any location, people are using cellular and digital telephones for multitasking activities such as getting stock quotes, emailing and texting friends and business associates, transmitting computer files, paging, checking traffic and weather reports, surfing the internet and much more. The desire to have a telephone on hand at all times has spawned the booming market of cellular communications and smartphone™ technology. Compact in size, most cellular phones and smartphones can fit in a briefcase, purse or pocket with ease. The popularity of cell phones has enjoyed phenomenal growth in recent years.

The present invention, hereinafter referred to as the Melt Crush MG, is a high-level smartphone featuring an affordable, international calling plan. This innovation includes the international calling program along with newly integrated and technologically advanced programs and applications. The device of the present invention offers cellular users an affordable and practical enhancement to the design of cellular telephones.

This device is a personal and business smartphone that can be likened to the efficiency of a computer with the ease of a portable device, a very beneficial invention to the global/cellular smartphone market. This is a unique smartphone of high quality with an integrated special program for international calling. When entering into the internal call program or IC program the view of the world map or globe appears. The sophisticated and multifaceted design of the world view can be turned or spun in any direction that you wish; north, south, west or east. A zoom-in zoom-out function is included on the global view. When making an international call, the owner rotates the globe until finding the country they would like to call. Upon clicking that specific nation, your personal contacts (phone numbers, emails, etc.) pictures, media files, or other kinds of files that are associated with your family and friends appear. In relation to personalizing and designing the international call program in your own way and style, making your own design can increase the uniqueness of your smartphone. You can design with your pictures, videos, music (media files), colors, other kinds of documents and files and personal contact info, etc.

When making the international call, the 011 international code, country code and the phone number will show up automatically for the person that you are calling. Otherwise, if the phone number for the person who you are calling has not been added yet to your personal contact info, the international code and country code will appear automatically and then the phone number of your calling destination can be typed in. Either way, once the phone number appears you are ready, tap the call button and make your international call. The international call is dialed and made with internet connection on this smartphone. The international call program makes international calls over or on the internet. International calling is established, based on the internet connection. An established safe and protected internet connection is made. With respect to the international calling program in its entirety, the program entails very important components that are demonstrated above, which make it unique and the first of its kind integrated and running on a smartphone. This is a specially designed interface that is very user friendly, simple, and effective with a clear purpose; making international calls portably via a smartphone in a cost effective and affordable way. The calling plan associated with the international call program may also be a flat-rate plan. This smartphone is a device with extremely high processing speeds, swift and speedy internet connection, enhanced, clear, and crisp sound for making local, long distance, and international calling. The local and long distance calling may or may not be associated with making calls with the internet connection. Calls may also be made traditionally. Within this invention, the smartphone and an international call program can be worked and can function from anywhere around the world. The invention herein is computing at its best, personal and portable.

New features, programs and applications include all up to date technology and applications for cellular smartphones, international call program, Melt Crush Perfect 2 program (bluetooth and earphones all in one device), security camera program for home, business and safe (money and jewelry), security alarm program for home, business and safe (money and jewelry), 2 or dual camera lenses for live video call chatting (camera pictures and videos), programs and applications App market, voice activation and voice control/command for entire smartphone including menus, contacts, and settings, receive and send WiFi signal (personal hotspot), multi-tasking while making calls, open several programs and applications at the same time, calendar, email, chat messaging, text messaging, visual voicemail, weather updates, world clock, voice recorder, tool display, digital memory, games, GPS navigation and navigational maps, e-book, 2 memory card slots for removable memory cards,(can store your personal contacts as well), trading and stock applications, new media programs and applications (pics and videos), video editing program, organize your files, folders and work easily, social networking applications and websites like Facebook, Twitter, Youtube and more, flexible moving of icons, screens and windows, Amber Alert safety notification system, easy and speedy uploads and downloads, advanced and swift Internet connection and high-level browsing capabilities,(view web pages like a computer and store favorites and history of websites visited) easy transfer of files to computer and vice versa, language translation program, satellite radio and mobile TV, water, dust and shock proof and is made up of sturdy materials. There may be a few different versions or packages of this invention.

The Melt Crush MG is a sophisticated high-level cellular phone or smartphone, which can slide open and with special hinges allow the phone to flip open like a book or laptop computer (screen may or may not be a touch screen). The Melt Crush MG can also feature another version with a touch screen keyboard. Another version may be solely a touch screen. Housed within the unit casing are the electronic components required to operate the unit. The electronic components include cellular phone circuit board, an antenna, microphone, speaker, keyboard and rechargeable battery (lasting up to 24 hours). The display panel and keyboard are externally accessible. Externally positioned on the plastic housing is a liquid crystal display panel and a series of alphanumeric, push-button switches used to key in telephone numbers and control the various operational functions of the smartphone.

The most notable aspect of the Melt Crush MG is found in its international calling capabilities, Bluetooth and earphones (all in one device), and new features, programs and applications. The Melt Crush MG revolves around extremely affordable international calling. This is accomplished by using a method currently used over the Internet like that of a chat or instant message program. In the Melt Crush MG innovation, this technology revolutionizes international calling, making it simple and cost effective. Specialized software (the international call program) is found on the Melt Crush MG to work this feature, and calls are crystal clear, as well as the connection. Calls within the United States can also be made with this same feature. International calls as well as local and long distance calls are unlimited ad under an affordable plan. This smartphone and its programs and features also work while travelling internationally; worldwide. This phone also functions safely with airline travelers in flight, depending on FAA guidelines.

The Melt Crush Mg also features the Melt Crush Perfect 2, a wireless set of earphones with crystal clear sound, Bluetooth capabilities with a built in microphone featured in the “right” earpiece. Flexible and comfortable, users rejoice in using these earphones which serve as both a Bluetooth and a listening device (earphones) for the music player or MP3 on this cleverly designed cellular smartphone.

Additionally, the Melt Crush MG has eminent software and hardware ideas and features embedded. This includes all updated technology, programs, and applications for current smartphones along with many new programs and applications specially designed for the Melt Crush MG.

All programs and applications specifically and specially designed for Melt Crush MG can be downloaded from the Melt Crush MG App store or App market. Other programs and applications can be downloaded to run on this invention from other app stores or app markets. Alternative mobile phones/smartphones can also download Melt Crush MG programs and applications and integrated/built-in programs and applications from the Melt Crush MG app store or app market.

Features include the capability to play and run picture slideshows, movies, video clips or alternative types of media on the main front screen or wallpaper (background) without having to enter other screens or programs to play the media. Media can also be viewed and played from screens like the media center or media program in this invention. Play and run different types of media as a screensaver, when powering on and off this smartphone. The screen that appears will play the media (pics, video clips, etc.) when powering on and off this smartphone. All the different media types for all the settings above are played and run for as long as the owner or user sets it for.

The device also includes two high mega pixel and high resolution cameras front and back (8.1 or higher) for pictures and videos; hard rive memory of 64 gigabytes or higher; high resolution screen (720 HD or higher) and high audio quality; an environmentally friendly smartphone, long life span of battery lasting 24 hours or more; low radiation emissions from this invention; charge this smartphone with its charger (regular method); charge wirelessly between charger or charging unit and smartphone; charge with solar charging directly to this smartphone or to the solar charging unit, or wirelessly solar charge between solar charging unit and smartphone; check and write notes on the notes program while being on the call; take and send pictures, videos and other large files to each other with an integrated/built-in program for transferring big files (also over 2 gigabytes) from Melt Crush MG to Melt Crush MG, or from Melt Crush MG to computer and vice versa. Also included is advanced voice activation; owner asks “what time is it?”, the smartphone answers 3:00 a.m. June 10 and year; owner says “missed calls” or “new text messages”, smartphone answers with results. Owner says “call mom” and smartphone dials. Owner states the number “3”, smartphone speed dials 3, which for example, happens to be Anthony; send text messages and emails while being on the call; send faxes of documents that you have to a Fax machine. It is capable of conference calling; set text messages, emails, and faxes to be sent automatically at a scheduled time; see live views of all cameras set up for home, business, safe, etc. on the integrated security camera program; an integrated security alarm program where the owner checks and controls home and business alarm, etc. and can enter the code for the security alarm in order to activate or unlock; can order food or groceries and have it delivered with an integrated application; order pizza and have it delivered with an integrated application; magnifying lens feature as a part of the high mega pixel camera; doctors can check medical files or records of their patient on the go in the medical database program on this smartphone in connection with their medical office or hospital; or doctors can check and write notes, details and reminders on the medical notes program on this smartphone; control air-conditioning and heat, lights, microwave, blinds, or curtains, television, sound/stereo system, toaster, coffeemaker and more items at home with an integrated program. Additionally, with this device you can program your remote control gate and garage to open and close from your smartphone; lock and unlock your home door or business door, etc. electronically with a code from your smartphone (program it as well.) For those who are in the real estate business, lock and unlock the real estate lock on the house you are selling electronically with a code from this smartphone (program it as well). An integrated application for checking personal blood sugar level and blood pressure by holding this invention a certain way or touching a specific area; an integrated application called “voice text” of which you create a text message by using your voice and saying letters or actual words. When finished composing the text message, by using your voice and saying “send”, you can send the text message. Upon receiving text messages, the same application can read aloud the text message you received.

A text message/calling and family related integrated program where parents can lock and unlock incoming and outgoing text messages and calls for a certain amount of time while their kids are driving. It can also be scheduled to unlock or lock automatically for a specific amount of time. In case of an emergency where the driver needs to dial or receive a call, they may also do so for a few contacts that are always set and programmed to be unlocked as for example the parents of the driver and 911, etc. The GPS monitor system is also part of this program, which parents can track the location of their kids while driving, walking to school or anytime.

A specially designed integrated application that is connected and secures your bank and credit card accounts with instant notification alerts signaling the owner of the accounts on his or her smartphone (this smartphone herein) that money is potentially going to be withdrawn or used from their account(s). This can be the case if someone is trying to withdraw money online illegally and wrongfully from someone else's bank account or is using three credit card. If this is true, an instantaneous message alert is sent directly to the owner of the account or to the person of which the account(s) belongs to on their smartphone. On the alert, it would include a security password or code that the owner can enter and then following this, a question that states yes or no on the amount being withdrawn or used for the approval of the owner. If the yes button is pressed, then the money will go through. If the no button is pressed, then an automatic lock is placed on the account(s). Then there will be a chance for the owner to figure out and see what is happening and to seek further details in relation to the incident. An option can be placed on this integrated application for usual alerts to be received on this smartphone signaling in a message the name of the person and the amount being withdrawn when for example the owner has previously written checks. The option can also have the security password and the yes or no approval of the owner. Additionally, a specially designed integrated application which is titled, “automobile repair system” comprises an OBD (On board diagnostic) auto scanner, in that when this smartphone is connected to cars that have the OBD jack (or similar jack or input), on the screen of this smartphone will appear what the problem is, what to do, where the problem is located demonstrated on a map or diagram, and if necessary how much the part will cost on average and places around you where you can go to make the repairs, etc. If there is an issue with a sensor in the car, where the problem is and what to do will also appear on screen. If everything is ok and functioning properly, that will emerge as well.

The Melt Crush MG is a fully functioning cellular telephone/smartphone which provides crystal clear sound in a sleek and easily operated package. Quality constructed of durable materials, this product will withstand years of continual use. This invention relates to worldwide telecommunications, portable and at its best. The device described herein is a smartphone that functions like a computer. With this invention, you are very independent in creating and building your own uniqueness, style, and way of working.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A cellular phone featuring an international calling plan with newly integrated and technologically advanced programs and applications, comprising: an LED screen and keyboard with sliding open capability, hinged flip open capability, and a touch screen.

2. The cellular phone of claim 1 further comprising special hinges which allow the phone to flip open like a book or laptop computer and the screen is a touch screen.

3. The cellular phone of claim 1 further comprising special hinges which allow the phone to flip open like a book or laptop computer and the screen is not a touch screen.

4. The cellular phone of claim 1 comprising internal call program or IC program showing a view of the world map or globe, wherein the world view can be turned or spun in any desired direction, further comprising a zoom-in zoom-out function included on the world view.

5. The cellular phone of claim 4 wherein the user rotates the globe until finding the country they would like to call, the user clicks on that specific nation, and personal contacts including phone numbers, emails, pictures, media files, or other kinds of files that are associated with the personal contact appear on the screen.

6. The cellular phone of claim 5, wherein the 011 international code, country code and the phone number will show up automatically for the person that you are calling when making an international call, and when the number appears on the screen, the user taps the call button to make the international call, and the international call is dialed and made with internet connection.

7. The cellular phone of claim 1 further comprising a specially designed integrated application which is titled, “automobile repair system” comprising an OBD (on board diagnostic) auto scanner, in that when this smartphone is connected to cars that have the OBD jack (or similar jack or input), on the screen of this smartphone will appear what the problem is, what to do, where the problem is located demonstrated on a map or diagram, and how much the part will cost on average and places around you where you can go to make the repairs, and wherein if there is an issue with a sensor in the car, where the problem is and what to do will also appear on screen, and wherein if everything is functioning properly, that information will appear on the screen also.
